(19) United States
(12) Patent Application Publication
(10) Pub. No.: US 2026/0292649 A1
(43) Pub. Date: Sep. 24, 2026

(54) SYSTEM AND METHOD FOR LEADER ELECTION AND TRAFFIC ROUTING IN TELECOMMUNICATION SYSTEMS

(71) Applicant: Huawei Technologies Co., Ltd., Shenzhen (CN)

(72) Inventors: Xu Li, Nepean (CA); Weisen Shi, Kanata (CA); Chenchen Yang, Ottawa (CA); Hang Zhang, Ottawa (CA)

(21) Appl. No.: 19/461,164

(22) Filed: Jan. 27, 2026

Related U.S. Application Data
(63) Continuation of application No. PCT/CN2023/110014, filed on Jul. 28, 2023.

(51) Int. Cl. H04W 40/02; H04W 40/24; H04W 84/20

(52) U.S. Cl. CPC H04W 40/02; H04W 40/248; H04W 84/20

(57) ABSTRACT

The present application relates to systems and methods for dynamic leader election in telecommunication systems, e.g., 3^{rd} generation partnership project (3GPP) 5th generation (5G) or 6^{th} generation (6G) system. An example method includes: receiving, by a network function in a communication network, one or more policies indicative of parameters for a leader election for a group of devices; performing, by the first network function, the leader election to elect a member of the group of devices as a leader device based on the one or more policies; and initiating, by the first network function, data plane path management operations to cause select traffic to be routed toward the leader device.

### CROSS-REFERENCE TO RELATED APPLICATIONS

This application is a continuation of International Application No. PCT/CN2023/110014, filed on Jul. 28, 2023, the disclosure of which is hereby incorporated by reference in its entirety.

### TECHNICAL FIELD

The present disclosure generally pertains to telecommunication systems such as 5th generation (5G) or 6th generation (6G) systems and, in particular, to a system and a method for leader device election and associated traffic routing in such telecommunication systems.

### BACKGROUND

For some applications (e.g. peer-to-peer gaming), and in the context of telecommunication networking, traffic may be required to be routed to a leader device (e.g. acting as game host) among a group of devices. The traffic is related to the application and is referred to as application traffic. The application traffic is originated or transmitted from one or multiple traffic sources (TS), each of which may be an application server (AS) or a device. In some scenarios, a device in the group of devices is a TS generating at least part of the application traffic. The leader may need to be dynamically elected from the group of devices, taking a number of factors into consideration, e.g. device status (like remaining energy, computing resource availability) and network status (throughput, delay). In various scenarios, a device among the group of devices should be dynamically elected as, or selected to be, the leader with respect to those factors (e.g. different devices act as the game host in turn in peer-to-peer gaming). The device elected as the leader is referred to as the leader device. Due to the current deficit in this area, there is a need to develop systems and methods of enabling such dynamic leader election in telecommunication systems, e.g. the 5G system or 6G systems.

The leader election problem described above may be viewed as a traffic routing problem, where the traffic is routed to a selected device. The application function (AF) influence on traffic routing feature in the 3^{rd} generation partnership project (3GPP) 5G system allows an AF to influence the session management function's (SMF's) traffic routing decision by providing traffic routing requirements. The traffic routing requirements are provided to the policy control function (PCF), which then transform them to policies and send the policies to relevant SMFs.

The AF influence on traffic routing feature in the 3GPP 5G system is limited to traffic routing to a data network (DN), where the traffic requirements indicate a list of potential application locations that the traffic should be routed to. The potential application locations are expressed by data network access identifiers (DNAIs), which identify locations where the DN can be accessed. When the SMF selects a user plane path (including user plane functions (UPFs)) to route the traffic, the SMF also selects a DNAI. The user plane path selection and the DNAI selection can be performed jointly to provide for user plane efficiency. However, such a feature cannot at present be used to solve the issues addressed in this application, which requires the traffic to be routed to a device, rather than toward a DNAI (e.g. a location identified by the DNAI).

Therefore, there is a need for leader election systems and methods which obviate or mitigate one or more limitations in the prior art.

This background information is provided to reveal information believed by the applicant to be of possible relevance to the present application. No admission is necessarily intended, nor should be construed, that any of the preceding information constitutes prior art against the present application.

### SUMMARY

Embodiments of this disclosure provide for systems and methods supporting dynamic leader election among a group of devices. Network functions, for example in a 3GPP 5G or 6G network operate to elect a leader from the group. Additionally, data plane path management operations are initiated or performed by such network functions to support interactions with the elected leader.

A technical effect according to various embodiments is the development and provision of systems and methods to support dynamic leader election in telecommunication systems, e.g. 5G or 6G systems. The dynamic leader election refers to selecting, from among a group of potential (candidate) devices, a device to be the leader device. Traffic is then routed to the selected leader device from other devices, referred to as traffic sources, which may be mobile devices, server devices, or the like, or a combination thereof. The leader may process the traffic and reply to the other devices or yet further devices. The traffic can be associated with one or more particular applications.

According to embodiments, there is provided a method performed in a communication network. The method includes the following operations by a first function, which may be a traffic coordination function (TCF). The method includes receiving one or more policies indicative of parameters for a leader election for a group of devices. The method includes performing the leader election to elect a member of the group of devices as a leader device, based on the policies. The method includes initiating data plane path management operations to cause select traffic to be routed toward the leader device.

In some embodiments, the method includes, by a second function, which may be a policy control function (PCF): receiving a request to perform the leader election for the group of devices; and sending, toward the first function, the one or more policies generated based on the request. In some embodiments, the request includes traffic information for use in identifying the select traffic for said causing the select traffic to be routed toward the leader device. In some embodiments, the request includes device information for use in identifying the group of devices. In some embodiments, the request includes device information for use in identifying one or more traffic sources generating the select traffic. In some embodiments, the request includes a leader election indication indicative that the leader election is to be performed. In some embodiments, the request includes traffic source selection information indicating whether or not all devices indicated by the device information can act as the traffic sources. In some embodiments, the request includes information indicative of validity conditions specifying time, location, or both time and location at which the first function is to perform the leader election. In some embodiments, the request includes information indicative of validity conditions specifying time, location, or both time and location at which the first function is to perform selection of the traffic sources. In some embodiments, the leader election indication includes information regarding whether the leader election is to be performed in one iteration or in multiple iterations. In some embodiments, the leader election indication includes leader election criteria to be respected or considered during the leader election. In some embodiments, the leader election criteria includes one or more of: computing power, remaining energy, availability of data, and sufficiency of data. In some embodiments, the leader election indication is further indicative that the select traffic is to be routed to the leader device. In some embodiments, the group of devices is separate, identical, or overlapping with the one or more traffic sources.

In some embodiments, the method further includes, by a third function, which may be an application function (AF), sending the request toward the second function.

In some embodiments, the select traffic includes data plane traffic from one or more traffic sources. In some embodiments, the select traffic is identified based on one or a combination of: a source address, a destination address, and one or more port numbers. In some embodiments, the data plane path management operations comprise selection of data plane paths toward the leader device, or selection of data plane paths from traffic sources generating the select traffic, or configuration of one or more data plane functions handling said select traffic, or a combination thereof. In some embodiments, the one or more data plane functions include a data plane function operating as a data plane anchor (DPA) for the leader device. In some embodiments, the one or more data plane functions include a data plane function operating as a DPA for one or more of the traffic sources.

In some embodiments, the method further includes, by the first function, selecting one or more traffic sources from the group of devices or from another group of devices, the traffic sources being potential sources of the select traffic.

In some embodiments, the leader election is performed at least in part taking into account current or statistical network status or network conditions, status of members of the group of devices, or a combination thereof.

In some embodiments, the data plane paths management operations include initiating notification to said member of the group of devices, that said member is selected to be the leader device. In some embodiments, the data plane paths management operations include initiating (e.g. via messaging, which may be a request, a command, etc. from the TCF to the PMF) operation of a path management function (PMF) to configure one or more data plane functions (DPFs) to detect and process select traffic and route the select traffic toward the leader device. In some embodiments, the notification that said member is selected to be the leader device is included in a non-access stratum (NAS) message sent to said member of the group of devices through a radio access network (RAN). In some embodiments, the PMF is integrated with the first function.

In some embodiments, the data plane paths management operations include initiating (e.g. via messaging) operation of a path management function (PMF) to select data plane (DP) paths for use in routing the select traffic from one or more traffic sources toward the leader device, routing traffic from the leader device to the one or more traffic sources, or both. In some embodiments, the method further includes, by the PMF, selecting the DP paths.

In some embodiments, the method includes, by the first function, following the PMF configuring the one or more DPFs, sending (or otherwise initiating) notification to the leader device that data communication involving the select traffic and routed toward the leader device is to be expected, that the leader device can start data communication, or both. In some embodiments, this notification is included in a non-access stratum (NAS) message sent to the leader device through a radio access network (RAN).

In some embodiments, the method includes, by the first function, following configuration of the one or more DPFs, sending (or otherwise initiating) notification to one or more traffic sources that the traffic sources can now perform data communication conforming to the select traffic and that such select traffic will be routed toward the leader device, that the traffic sources can now expect to receive data traffic from the leader device, or both. In some embodiments, this notification is included in one or more non-access stratum (NAS) messages sent to the traffic sources through a radio access network (RAN).

In some embodiments, the method includes, by the first function, receiving a notification from the leader device that the leader device has determined to stop acting as the leader device; and in response to the notification that the leader device has determined to stop acting as the leader device, initiating a next iteration of leader device selection and associated data path management. In some embodiments, this notification is included in a non-access stratum (NAS) message sent to the traffic sources through a radio access network (RAN).

In some embodiments, configuration of the DPFs comprises configuring the DPFs to perform destination address translation in packets of the select traffic. The destination address translation facilitates routing of the packets toward the leader device while masking an address of the leader device from sources of the packets of the select traffic. In some embodiments, configuration of the DPFs comprises configuring the DPFs to perform source address translation in packets of return traffic from the leader device. The source address translation facilitates routing of the return packets while masking an address of the leader device from destinations of the packets of the return traffic. In some embodiments, this configuration is performed according to address translation information indicative of the destination address translation, the source address translation, or both, and the address translation information originates from or is received from a second function (e.g. policy control function (PCF)). In some embodiments, the address translation information indicates one or more network addresses that are to be translated and one or more translated network addresses that the one or more network addresses are to be translated into. The method may further include, by the DPFs, performing the destination address translation, the source address translation, or both.

In some embodiments, configuration of the DPFs includes configuring the DPFs to perform traffic gating to drop traffic originating from devices other than selected traffic sources. Such configuration may be performed according to traffic gating information indicative of network addresses of the devices other than the selected traffic sources, and the traffic gating information may originate from or be received from a second function (e.g. a policy control function (PCF)). The method may further include, by the DPFs, performing such traffic gating.

In some embodiments, the method includes initiating notification to an appropriate member of the group of devices, that this member is selected to be the leader device.

According to embodiments, there is provided another method performed in a communication network. The method includes the following operations by a first function, such as a traffic coordination function (TCF). The method includes initiating notification to a device, belonging to a group of devices, that the device is selected to be a leader device. The method includes initiating, e.g. via messaging, operation of a path management function (PMF) to configure one or more data plane functions (DPFs) to detect and process select traffic and route the select traffic toward the leader device.

Various embodiments of the above method may be provided for, for example as already described above with respect to the first method, or as described elsewhere herein.

According to embodiments, there is provided a first function, such as a traffic coordination function (TCF) in a communication network. The first function includes processing electronics and a network interface. Here and elsewhere, a function can include hardware resources such as processing electronics and network interface, in the sense that it is instantiated using such hardware resources. The first function is configured to receive one or more policies indicative of parameters for a leader election for a group of devices. The first function is configured to perform the leader election to elect a member of the group of devices as a leader device, based on the policies. The first function is configured, e.g. following the leader election, to initiate data plane path management operations to cause select traffic to be routed toward the leader device.

According to embodiments, there is provided a system in a communication network including the above-described first function, and one or more additional functions. Different functions can be instantiated using the same or different hardware resources. The additional functions can include a second function (e.g. policy control function (PCF)) configured to receive a request to perform the leader election for the group of devices, and to send, toward the first function, the one or more policies generated based on the request. The additional functions can include third function, such as an application function (AF), configured to send the request toward the second function. The additional functions can include a path management function (PMF). The data plane paths management operations can include initiating, e.g. via messaging, operation of a path management function (PMF) to select data plane (DP) paths for use in routing the select traffic from one or more traffic sources toward the leader device, routing traffic from the leader device to the one or more traffic sources, or both. Furthermore, the PMF may be configured to select the DP paths.

The additional functions can include one or more data plane functions (DPFs). The data plane paths management operations can include initiating notification to the member of the group of devices, that the member is selected to be the leader device. The data plane paths management operations can include initiating, e.g. via messaging, operation of a path management function (PMF) to configure the one or more data plane functions (DPFs) to detect and process select traffic and route the select traffic toward the leader device. The DPFs may be configured to perform address translation, traffic gating, or both.

According to embodiments, there is provided a first function, such as a traffic coordination function (TCF), in a communication network, comprising processing electronics and a network interface. The first function is configured to initiate notification to a device, belonging to a group of devices, that the device is selected to be a leader device. The first function is configured to initiate operation of a path management function (PMF) to configure one or more data plane functions (DPFs) to detect and process select traffic and route the select traffic toward the leader device.

According to embodiments, there is provided a system in a communication network including the above-described first function, and one or more additional functions. The additional functions can include the PMF, where the PMF is configured to select the DP paths. The additional functions can include the DPFs, where the configuration of the DPFs includes configuring the DPFs to perform address translation, traffic gating, or both, and where the DPFs are configured to perform said address translation, traffic gating, or both.

Other aspects of the above functions and systems can be provided, such as aspects similar to those aspects of the methods as already described above.

In accordance with embodiments, there is provided an electronic apparatus in a communication network, the apparatus comprising a processor, a network interface and a memory and configured to perform one or more of the methods as described herein. In accordance with embodiments, there is provided a system of such electronic apparatuses, networked together and configured to interact to perform one or more of the methods as described herein.

In accordance with an embodiment of the present disclosure, there is provided a computer program product comprising a (e.g. non-transitory) computer readable medium having statements and instructions stored thereon which, when executed by one or more computer processors, cause the computer processors to perform the method as set forth above. The computer processors may be parts of one or more electronic apparatuses (e.g. network entities) as described herein.

Embodiments have been described above in conjunctions with aspects of the present application upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present application will become apparent from the following detailed description, taken in combination with the appended drawings, in which:

FIG. 1 illustrates a system including various network functions and networked devices, in accordance with embodiments of the present disclosure.

FIG. 2 illustrates a group of devices, data plane functions, traffic sources, and a leader device, in accordance with an example embodiment of the present disclosure.

FIG. 3 illustrates operation of various network functions in relation to an AF request, according to embodiments of the present disclosure.

FIG. 4 illustrates messaging between various network functions and devices in order to carry out embodiments of the present disclosure.

FIG. 5 illustrates an electronic device which may be configured to perform operations according to embodiments of the present disclosure.

It will be noted that throughout the appended drawings, like features are identified by like reference numerals.

### DETAILED DESCRIPTION OF ILLUSTRATIVE EMBODIMENTS

Embodiments of the present disclosure relate to dynamic leader election among a group of devices. This may be applicable in scenarios involving peer-to-peer traffic between devices, for example in support of certain applications (such as peer-to-peer gaming). The traffic may be associated with such an application and explicitly indicate (e.g. by including a particular network address as destination address) the application in the packets thereof. In some such applications, there is a leader device which receives traffic from other devices, and which may also send traffic to the other devices. A device can, for example, be a wireless terminal device such as a user equipment (UE), a M2M device, a MTC device, an IoT device, a server, a network function, or the like.

As used herein, the term “leader” refers to a role which can be assigned to a first device in a group of devices, so that the first device is selected or elected as the leader. Once the first device is assigned with the leader role, the first device becomes a leader device. The device is thus said to be selected to be the leader or elected as the leader. The leader role can later be moved from the first device to a second device in the group of devices such that the second device becomes a leader device and the first device stops being a leader device.

Leader election may refer to a process of electing a device as leader, in other words, selecting a device to be the leader. Leader election can also be considered to be a process of assigning the leader role to a device such that the device becomes a leader device. Leader election may be performed among a group of devices. Accordingly, a device among the group of devices is elected as (selected to be) the leader, i.e. assigned with the leader role. The leader role can be moved from device to device in the group of devices such that the leader device changes dynamically.

For ease of description, various illustrative embodiments are presented in which a single group of devices is present. The leader device is selected from the group of devices, and the leader device receives traffic from some traffic source(s). The traffic sources are also generally considered to belong to the same group of devices, i.e. are other devices in the same group of devices. However, other embodiments are also considered. For example, the leader device may be selected from a first group of devices (referred to as potential leaders or equivalently candidate leaders), while the traffic sources or other associated devices may belong to (or be selected from) a second group of devices (referred to as candidate traffic sources). Traffic sources may be referred to as potential traffic sources in the sense that they may generate traffic, but they do not necessarily generate traffic, even if they are selected from a set of candidate traffic sources. The first group of devices (wherein members are candidate leaders) and the second group of devices (wherein members are candidate traffic sources) may be the same (identical), different (separate), overlapping (having one or more members in common) or non-overlapping (having no members in common). The traffic sources may be selected from the second group of devices.

In various embodiments, the leader device receives traffic from the traffic sources. The leader device is selected from the first group of devices as described above. According to various embodiments, the traffic is related to or associated with an application, and the leader device acts as an application server associated to the application and processes the traffic. The traffic may include information indicating that the traffic is associated with the application, for example, by including a particular network address as destination address (and possibly a particular port number as destination port) in the packets thereof, and can accordingly be identified or detected among other traffic. The first group of devices can be considered potential (or candidate) locations of the application, i.e. potential locations where an application server associated to the application is located, or simply put, potential application servers associated to the application).

According to various embodiments, an application function (AF) can request to perform leader election by sending an AF request. The AF request includes leader election requirements. The AF request is sent to a policy control function (PCF) and the PCF transforms the request to policies to be followed (i.e. generates the policies according to the request). The PCF sends the generated policies to a traffic coordination function (TCF), and the TCF elects the leader (e.g. selects the leader device) accordingly. The TCF instructs a path management function (PMF) to route traffic toward the leader (the leader device). The PMF accordingly selects and configures data plane paths. The leader election can be performed in multiple iterations, for example multiple times periodically or intermittently. The TCF may receive a notification from the current leader device, and, according to the notification, will determine whether a current iteration of leader election is completed, determine whether to start a next iteration of leader election, or both. Although the terms “TCF,” “PCF,” “AF,” etc. are used herein for clarity of description, it should be understood that these names can be changed and these functions can be replaced with equivalent functions. Thus, the TCF can be a first function, the PCF can be a second function, the AF can be a third function, etc.

The PMF configures an anchor data plane function (DPF), a.k.a. data plane anchor (DPA), of the leader device so that traffic targeting the leader is routed to the leader device. The PMF configures anchor DPF(s) (a.k.a. DPA(s)) of other (non-leader) devices, in other words, traffic sources, so that traffic originating from those other devices and targeting the leader is routed to the anchor DPF of the leader device. A DPA of a device (the leader device or a non-leader device as described above) may be associated to a session (e.g. a PDU session in the 5G system) of the device, the session being used to transport the traffic. In this case, the DPA is for the session and is also referred to as session anchor (e.g. PDU session anchor (PSA) in the 5G system). The DPA of the leader device routes the traffic, i.e. traffic targeting the leader, to the leader device along a data plane (DP) path connecting the leader device and the DPA of the leader device. When the DPA of the leader device is associated to a session of the leader device as described above, the DP path is associated to the session. Note that ‘leader’ is a role, and the leader role can be assigned to a first device (in other words, the first device is selected or elected as the leader). Once the first device is assigned with the leader role, the first device becomes a leader device. The leader role can later be moved from the first device to a second device, such that the second device becomes a leader device and the first device stops being a leader device.

In various embodiments, after the TCF makes a leader election decision, i.e. selects a device to be the leader, the TCF notifies the device about the leader election decision, that is, the TCF notifies the device that the device is selected to be the leader.

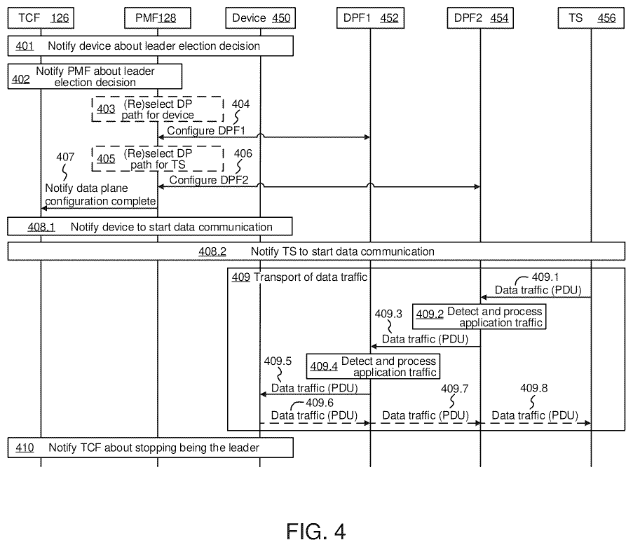

The PCF generate policies according to the AF request. The policies include information identifying the traffic and information about traffic routing requirements,. The PCF sends the policies to a TCF, where the TCF serves devices associated with (e.g. generating/originating or receiving) the identified traffic. According to the policies, the TCF performs the leader election in one or multiple iterations. In each iteration, the TCF selects a device from a group of devices (i.e. candidate leaders, which may include some or all of the devices associated with the identified traffic) to be the leader and performs a data plane path (re)selection procedure as illustrated in FIG. 4.

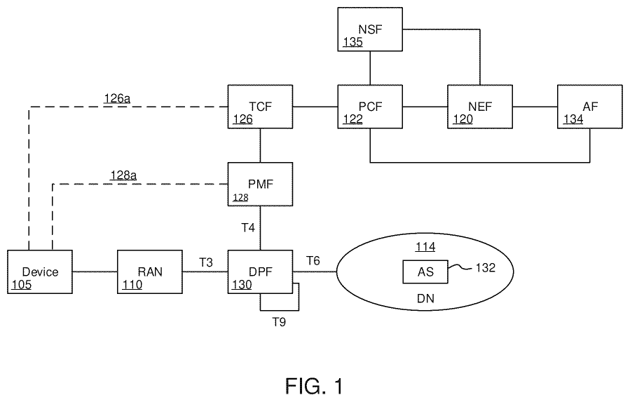

FIG. 1 illustrates a system provided in accordance with embodiments of the present disclosure. The system includes a device 105 (e.g. UE), a radio access network (RAN) 110, a core network (CN) and a DN 114. The CN includes a control plane and a data plane. The control plane includes the following control plane functions: NEF 120, PCF 122, NSF 124, TCF 126, and PMF 128. The data plane includes a data plane function (DPF) 130. In some embodiments, for example, when the system is a 3GPP 5G system, the data plane is known as user plane. The DN 114 includes an application server (AS) 132. The system further includes an application function (AF) 134. The AF 134 interacts with the control plane of the CN in order to access or provide services. In some embodiments, for example, when the AF 134 is located in a trust domain, the AF 134 is allowed to interact directly with relevant control plane functions, e.g. NSF 124, PCF 122. In some embodiments, for example, when the AF 134 is not located in a trust domain, the AF 134 is not allowed to interact directly with the control plane functions, but instead interacts indirectly with the control plane functions via the NEF 120.

Further details of various components (e.g. functions) of FIG. 1, according to various embodiments, are described below.

The NEF 120 may implement functionalities such as, but not necessarily limited to: exposure of network information, analytics, capabilities and events, secure provisioning of information from external application (e.g. AF) to the system, translation of internal-external information, etc. In some embodiments, the NEF corresponds to the NEF in a 3GPP 5G system.

The PCF 122 may implement functionalities such as, but not necessarily limited to: support of unified policy framework to govern network behavior, making policy decisions and providing resultant policy rules to control plane function(s) to enforce them, accessing subscription information and application data relevant for policy decisions in one or multiple network storage functions (e.g. NSF). In some embodiments, the PCF corresponds to the PCF (policy control function) in the 3GPP 5G system. In some embodiments, the PCF may correspond to an aspect of a 5G PCF.

The NSF 135 may implement functionalities such as, but not necessarily limited to: storage and retrieval of subscription data, storage and retrieval of policy data, storage and retrieval of structured data for exposure, storage and retrieval of application data (including Packet Flow Descriptions (PFDs) for application detection, information associated with AF request, device group information for group management), etc. In some embodiments, the NSF corresponds to the UDR (unified data repository) in the 3GPP 5G system. In some embodiments, the NSF may correspond to an aspect of a 5G UDR.

The TCF 126 makes traffic routing decisions and coordinates traffic routing, as described elsewhere herein. In some embodiments, the TCF is integrated with the PMF 128. In some embodiments, the TCF is integrated with the PCF 122. The integrated functions can be the same entity, for example. In some embodiments, the TCF is a separate network function, different from the PMF 128 and the PCF 122. The TCF interacts with the device 105 via an interface 126a shown as a dashed line. The interface 126a may be viewed as an NAS (Non Access Stratum) interface. The interface 126a passes through the RAN 110. In some embodiments, the interface 126a is also through one or multiple other network function, e.g. the PMF, the AMF in the 3GPP 5G system, or a combination thereof.

The PMF 128 may implement functionalities such as, but not necessarily limited to: selection and control of the DPF, maintaining/configuring data plane topology or paths, establishing and releasing data plan tunnels, configuring traffic forwarding at DPF to apply local switching or packet forwarding, configuring traffic steering at DPF to route traffic toward a proper destination, etc. The PMF configures a DPF 130 via the illustrated T4 interface. In some embodiments, the PMF corresponds to the SMF (session management function) in the 3GPP 5G system. The PMF interacts with the device via an interface shown as dashed line 128a. The interface 128a may be viewed as an NAS (Non Access Stratum) interface. The interface 128a is through the RAN. In some embodiments, the interface 128a is also through another network function, e.g. AMF in the 3GPP 5G system (not shown in FIG. 1). This other network function is between the RAN and the PMF. In some embodiments, the PMF may correspond to an aspect of a 5G SMF.

The DPF 130 may implement functionalities such as, but not necessarily limited to: acting as a point of interconnect to the DN 114, acting as an anchor point for a device 105 in the DP, routing/forwarding packets, enforcing policy rules (e.g. traffic gating, redirection, traffic steering), performing traffic marking in the uplink and downlink, performing packet buffering and data notification triggering, performing packet inspection (e.g. application detection). In some embodiments, the data plane corresponds to the user plane of the 3GPP 5G system, and the DPF corresponds to the UPF (user plane function) in the 3GPP 5G system.

The control plane functions and the DPF, as described above, may be logical network functions; each of them can be instantiated at one or multiple network locations, resulting in one or multiple instances. When a RAN implements functionalities of a logical network function (any of the control plane functions and the DPF), it is considered that the logical network function is instantiated at the RAN node. A network location may refer to a data center or a RAN node. There may be more than one instances of a logical network function at a same network location. In various embodiments described in this disclosure, selecting or reselecting a logical network function corresponds to selecting or reselecting an instance of the network function.

The device 105 connects to the CN via the RAN 110. The device is served by a RAN node in the RAN, i.e. having a wireless connection with the RAN node. The serving RAN node of the device connects with the DPF (in fact, an instance of the DPF) through a data plane (DP) path. The instance of the DPF is an anchor point for the device in the data plane and can be referred to as DPA. The data plane path is associated to the device 105; the data plane path includes the serving RAN node, the DPA and possibly other instance(s) of the DPF. When the other DPF instances are included in the data plane path, the other DPF instances are located between the serving RAN node and the DPA along the data plane path and connect the serving RAN node and the DPA. The serving RAN node connects with a DPF instance in the data plane path the via the T3 interface. Two adjacent DPF instances in the data plane path are connected via the T9 interface.

The DN 114 can be a real DN (which includes or is associated with one or multiple application servers such as AS 132), and the DPA connects to the DN via the T6 interface. The DN 114 can be a virtual DN (which, for example, does not include or is not associated with any application servers). The DN 114 may correspond to an application or an application scenario, and the DNN can be used to identify the application or the application scenario.

A particular embodiment of the present disclosure will now be described. In this embodiment, in implementing an application, traffic (a.k.a. data traffic) is to be routed to a leader among a group of devices. The traffic is related to the application and is referred to as application traffic. The application traffic originates or is transmitted from one or multiple traffic sources (TS), each of which may be an application server (AS) or a device. In some embodiments, a device in the group of devices (or in another group of devices) is a TS generating at least part of the application traffic.

Leader selection can be performed according to a request from an AF associated to the application as described below.

The group of devices are each associated with a data plane path that is used to transport the application traffic. The data plane path may be associated to a session (e.g. a PDU session in the 5G system) of the respective device. If a device is elected as leader, the application traffic is routed to the DPA of the device and then transported to the device along the associated data plane path. If the device is not elected as the leader, the device may generate at least part of the application traffic, and this at least part of the application traffic is transported along the associated data plane path to the DPA of the device, and then routed or forwarded to the DPA of the leader device from the DPA of the device.

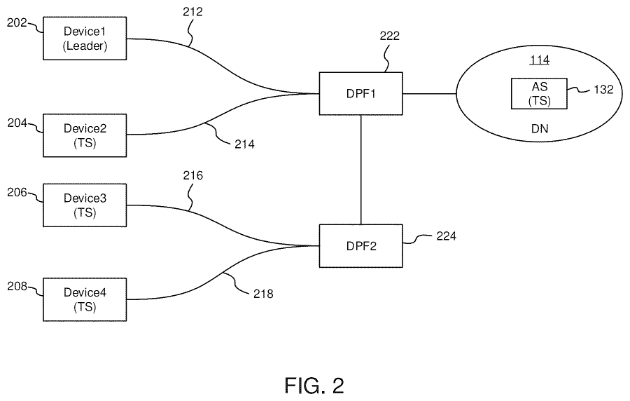

FIG. 2, in relation to the present embodiment, illustrates a group of four devices, device1 202, device2 204, device3 206 and device4 208 and their associated data plane paths 212, 214, 216, 218, respectively. The data plane paths 212, 214 associated to device1 202 and to device2 204 share the DPF1 222 as DPA. The data paths 216, 218 of device3 206 and device4 208 share the DPF2 224 as DPA. The device1 202 is elected as the leader. As shown in FIG. 2, each of the device2 204, device3 206 and device4 208 may be a TS, generating at least part of the application traffic. An AS 132 in the DN 114 may also act as a TS and generate at least part of the application traffic. Thus, data traffic (e.g. the application traffic) may be routed to the leader device 202 from one, some or all of device2 204, device3 206, device 4 208 and the AS 132. The application traffic generated by the device3 206 and the device4 208 are routed to the DPF2 224 respectively along their data plane paths 216, 218. The DPF2 224 forwards/routes the application traffic toward the DPF1 222, i.e. the DPA of the leader device. As the DPA of device1, the DPF1 222 also receives the application traffic generated form device2 204. DPF1 222 sends the application traffic received from device2 204 and that received from DPF2 224 to the device1 202 along the data plane path 212 of the device1.

The data plane path of a device (e.g. device1, device2, device3 or device4 in FIG. 2) may be associated to a session (e.g. a PDU session in the 3GPP 5G system) of the device and the data plane path may be selected and configured during establishment of the session. The device may request establishment of a session by sending a session establishment request to the system, e.g. to the TCF or to the PMF. The session establishment request may include information identifying the device, information identifying a DN (e.g. a DNN), network slice information (which can be used to select a network slice), etc. If the request is sent to the TCF, the TCF may send at least part of the information in the request to the PMF so that the PMF can establish the data plane path. If the request is sent to the PMF, the PMF may send at least part of the information in the request to the TCF so that the TCF can take into account the device when performing traffic coordination related to the DN, the network slice, or a combination thereof. The session is associated to the application. The application may be identified by the information identifying the DN, the network slice information, or the combination thereof.

A device in a group of devices (e.g. the group of devices described above) may access the application through a data plane path of the device and transmit or receive traffic related to the application (i.e. part of the application traffic described above) along the data plane path. The data plane path includes a data plane function that acts as a data plane anchor (DPA) of the device. The data plane path is managed by a path management function (PMF), and as described above, may be associated to a session of the device, the session being associated to the application. The device is considered to be served by the PMF for the application, and the PMF is referred to as the serving PMF of the device for the application. Similarly, the session is considered to be served by the PMF, and the PMF is referred to as the serving PMF of the session. Another device, or a session of another device in the group of devices may also be served by the PMF, or by a different PMF for the application. In some embodiments, the group of devices are all served by the PMF.

When the TCF and the PMF are not integrated, the PMF may inform the TCF that the PMF is serving the device for the application or is serving the session of the device, the session being associated to the application. The PMF may inform the TCF of this by sending a message to the TCF, the message including information identifying the device, information identifying the session, and information identifying the application. In some embodiments, the relationship between the PMF and the device, i.e. the PMF is serving the device for the application, is maintained in a network binding function (NBF). The NBF may store the mapping between the device (e.g. identified by a device ID) and the PMF (e.g. identified by a PMF ID) for the application (e.g. identified by an application ID). In some embodiments, the relation between the PMF and the session of the device, i.e. the PMF is serving the session, is maintained in the NBF. The NBF may store the mapping between the session (e.g. identified by a session ID) and the PMF (e.g. identified by a PMF ID). The NBF may further store an application ID identifying the application that the session is associated to. In some embodiments, the application ID is in the form of a DNN, a network slice ID, or a combination thereof. The TCF may subscribe to receive the mapping (i.e. the mapping between the device and the PMF or the mapping between the session and the PMF as described above) from the NBF for the application.

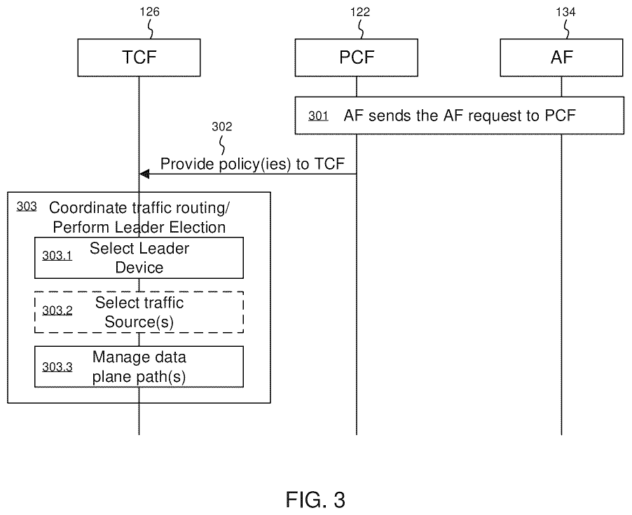

Embodiments provide for provisioning of leader election requirements, for example as follows and as illustrated in the FIG. 3. As already described above, the AF can request a leader election for the group of devices, wherein a device is elected as (in other words, selected to be) the leader among the group of devices, such that the application traffic is routed to the leader device through the data plane. The leader election may be performed in one or multiple iterations. In each iteration, a device is selected from the group of devices to be the current leader, and the application traffic is routed to the leader device. In different iterations, different devices may be selected to be the leader. Accordingly, the respective leader devices may be different at different times, and the application traffic is therefore routed to the different devices at different times. The different iterations may be performed sequentially, one after another. The leader election may be performed by the traffic coordination function (TCF).

When requesting the leader election be performed, the AF sends (e.g. operation 301 in FIG. 3) a request, referred to as AF request. The AF request may include some or all of the following information: traffic information, device information, leader election indication, traffic source selection information, and information about validity conditions. Such information may be as described below.

The traffic information identifies the application traffic and, in some embodiments, the application. The traffic information may include a DNN and possibly network slice information (which can be used for selecting a network slice), or an AF-Service-Identifier (i.e. an identifier of the service on behalf of which the AF is issuing the request). When the AF-Service-Identifier is included in the traffic information, the AF-Service-Identifier is mapped to a target DNN and possibly network slice information, e.g., by the NEF. When the NEF processes the AF request the AF-Service-Identifier may be used to authorize the AF request. The traffic information may include an application identifier or traffic filtering information (e.g. IP 5 Tuple). The application identifier identifies, refers or corresponds to the application (which handles DP traffic) and can be used by the DPF to detect the application traffic. The traffic information may be for use in identifying select traffic for causing the select traffic, e.g. data plane traffic, to be routed toward the leader device. The select traffic is traffic which is determined to be appropriate for routing toward the leader device, and may relate to an application being supported. In various embodiments, the select traffic may be identified based on one or a combination of: a source address, a destination address, and one or more port numbers. The select traffic is transported for example according to operation 409 of FIG. 4.

The device information identifies a first group of devices. The device information may further identify a second group of devices. The first group of devices includes candidate leaders, i.e. devices that can be selected as the leader. The second group of devices includes candidate traffic sources, i.e. devices that can be selected as traffic sources. Application traffic originating from a device selected as traffic source is authorized traffic and will be routed to the leader. Application traffic originating from a device not selected as traffic source is not authorized and will not be routed to the leader (for example, dropped instead). In various embodiments, the first group of devices and the second group of devices may be the same (identical), different (non-identical), overlapping (having one or more members in common) or non-overlapping (separate, having no members in common).

In some embodiments, the first group of devices, i.e. candidate leaders, are considered and identified as potential (or candidate) locations of the application, and the second group of devices, i.e. candidate traffic sources, are considered and identified as devices whose traffic is to be routed (here, the traffic refers to the application traffic identified in the traffic information). The device information comprises information identifying the first group of devices and information identifying the second group of devices.

Each of some, or all of a group (whether the first group or the second group) of devices identified in the device information may be identified as respective individual devices. An individual device can be identified using a device ID or an address (e.g. IP address/prefix, MAC address). Some, or all of the group of devices may be identified together as a device group. A device group can be identified using a group ID. The group of devices may include any device accessing the application. Hence, for the group of devices (e.g. the first group of devices or the second group devices), the device information (more specifically, the information identifying the group of devices in the device information) may include a list of device ID(s), a list of address(es), a list of group ID(s), information (e.g. a special group ID, or a special device ID) indicating any device accessing the application. A device ID or a group ID in the device information may be an external ID, i.e. an external device ID or an external group ID, and in this case, it may be mapped to an internal ID, i.e. an internal device ID or an internal group ID, by the NEF when the NEF processes the AF request. In some embodiments, for a device or a device group identified in the device information, the device information may indicate whether the device, or the device group (i.e. any device in the device group) is a candidate leader or a candidate traffic source or both (i.e. belongs to the first group, the second group or both groups).

The leader election indication indicates that a device should be selected (e.g. to be the leader) from the candidate leaders identified in the device information and that the application traffic identified in the traffic information and belonging to the traffic sources should be routed to the selected device (i.e. the leader device). In some embodiments, the leader election indication is considered or viewed as traffic routing requirements. In some embodiments, when the candidate leaders are considered potential locations of the application, leader election can refer to selection of a common application location, and the leader election indication implies a common application location (i.e. a leader device) should be selected from the potential locations of the application (i.e. the candidate leaders) for the traffic sources so that the application traffic of the traffic sources is routed to the common application location. The traffic sources mentioned above include some or all of the candidate traffic sources identified in the device information, and may be determined as a result of traffic source selection described below (e.g. in association to operation 303.2 in FIG. 3). The leader election indication may include information indicating whether the leader election should (is to) be performed in one or multiple iterations. This information may further indicate the number of iteration(s)/time(s) that the leader election should be performed, which is an integer value not less than 1 (e.g. equal to or greater than 1). This information may be optional and may be omitted in some embodiments. When this information is not present in the leader election indication, it may imply that the number of iterations/times is set to a predetermined default value, e.g. 1.

The leader election indication may include information about leader election criteria. The information about leader election criteria may specify factors that should be respected or considered when electing the leader (i.e. selecting the leader device). For example, this information may specify a type of device that the leader should be. As another example, information may specify minimum capabilities (e.g. in terms of computing power, remaining energy, availability or sufficiency of data) that the leader should have. As another example, the information may specify location (e.g. one or multiple location areas) where the leader should be. The information can specify one or multiple such factors. In some embodiments, this information specifies the device to be elected as the leader, by including information identifying the device, e.g. a device ID, a network address. Among the candidate leaders identified in the device information, a qualifying device as specified in this information can be elected as the leader. The information about leader election criteria may specify how often, or how likely a qualifying device can be elected as the leader. In some embodiments, the information about leader election criteria specifies each qualifying device is equally likely being selected to be the leader. When the leader election is to be performed in multiple iterations, the information about leader election criteria may be for all the iterations or be per iteration and should be respected or considered during the corresponding iteration of leader election. The information about leader election criteria is optional.

The traffic source selection information may include traffic source selection requirements, which indicate how to select devices from the candidate traffic sources identified in the device information to be traffic sources. The traffic source selection requirements may specify a minimum, maximum or exact number of devices to be selected as traffic sources. The traffic source selection requirements may specify a threshold value (or a range) that total amount of data available at the selected traffic sources should or should not be below or beyond (or within). The traffic source selection information may further indicate whether traffic sources need to be reselected in each iteration of leader election. The traffic source selection information may indicate all the candidate traffic sources as identified in the device information should be selected as traffic sources. The traffic source selection information may be optional and may be omitted in some embodiments. In various embodiments, if this information is absent (i.e. not present), it may imply for example that all the candidate traffic sources identified in the device information should be selected as traffic source. When it is indicated that all the candidate traffic sources should be selected as traffic source (e.g. as indicated in the traffic source selection information or as implied by the absence of the traffic source selection information), traffic source selection (e.g. operation 303.2 in FIG. 3) can be considered not performed or equivalently speaking, performed with simply selecting all the candidate traffic sources.

In various embodiments, according to the traffic source selection information, the TCF selects (e.g. operation 303.2 in FIG. 3) one or multiple devices from the candidate traffic sources identified in the device information as traffic sources, and the DPF performs traffic gating to drop application traffic originated from any device that is not selected as a traffic source. The selection of the one or multiple devices as traffic sources may be required to respect the traffic source selection requirements such that the requirements are satisfied. In various embodiments, if no candidate traffic sources are identified in the device information, the TCF will not select traffic sources (e.g. will not perform operation 303.2 in FIG. 3), and the DPF will not perform the traffic gating.

The information about validity condition(s) specifies conditions (e.g. when, where, or both when and where) under which the leader election is to be performed. The information about validity condition(s) may include information about a temporal validity condition, information about a spatial validity condition, or both. The information about the temporal validity condition may specify when the leader election should be performed, by specifying time interval(s) or duration(s). The information about the spatial validity condition may specify validity area(s) where the leader election should be performed. For example, the information may indicate that the leader election should be performed only for devices located in one or more specified validity areas, that is, that a leader device should be selected from candidate leaders identified by the device information and located in one or more specified validity areas. A validity area in the information about spatial validity condition may be expressed by a zone ID, and in this case, it may be mapped to one or multiple cell IDs, by the NEF when the NEF processes the AF request. The TCF may perform (e.g. operation 303.1 in FIG. 3) selection of a leader device, for example according to the leader election indication and the validity condition(s) specified by the information about validity condition(s).

Similarly, information about conditions under which traffic source selection is to be performed may also be specified. This information may be included in the information about validity conditions or elsewhere. This information may be included in an AF request (e.g. the AF request described above), polici(es) generated by the PCF, or the like, or a combination thereof. The information about conditions under which traffic source selection is to be performed may specify when the traffic source selection should be performed, for example by specifying time intervals. The information about conditions under which traffic source selection is to be performed may specify where the traffic source selection should be performed, for example by specifying spatial locations or areas within which candidate traffic sources should be in order to qualify as candidates. Such an area may be expressed using a zone ID. Generally, the above information may be referred to as information indicative of validity conditions specifying time, location, or both time and location at which selection of the traffic sources is to be performed, e.g. by the TCF.

FIG. 3 illustrates operation of the AF, the PCF and the TCF in relation to an AF request, according to embodiments of the present disclosure. The AF request may be a request to perform a leader election for a group of devices, such that related traffic is routed to the leader device through the data plane.

In operation 301, the AF makes a request which is transported from the AF 134 to the PCF 122. In some embodiments, the AF request is sent to the PCF, directly or indirectly (e.g. via the NEF 120). When the AF is located in a trust domain or when the AF is allowed to interact with the PCF directly, the AF request may send the AF request to the PCF directly without involving the NEF. When the AF is not located in a trust domain or when the AF is not allowed to interact with the PCF directly, the AF may send the AF to the PCF via the NEF. That is, the AF sends the AF request to the NEF which in turns sends the AF request to the PCF. Before sending the AF request to the PCF, the NEF may perform information mapping such that, when the AF request is being sent to the PCF, the AF request includes mapped information (i.e. information mapped from information in the AF request that the NEF received from the AF). The AF request may be a request to perform a leader election for a group of devices.

In some embodiments, the AF request is sent to the NSF 135 (directly or via the NEF 120), and the NSF stores the AF request as application data. The PCF 122 subscribes to receive application data related to the application from the NSF. The NSF provides the AF request to the PCF according to the subscription. In some embodiments, the PCF performs the subscription when the PCF receives request (e.g. from the TCF) for policies related to the application. In some embodiments, the AF sends the AF request to the NEF 120, and the NEF sends the AF request to the NSF. Before sending the AF request to the PCF, the NEF may perform information mapping such that, when the AF request is being sent to the NSF, the AF request includes mapped information (i.e. information mapped from information in the AF request that the NEF received from the AF).

When the NEF 120 is involved as described above during the transport of the AF request from the AF to the PCF, the NEF may process the AF request before sending the AF request to the next network entity (e.g. the PCF 122 or the NSF 135). When processing the AF request, the NEF may perform information mapping, in which the NEF replaces or updates some information in the AF request with mapped information so that the next network entity receives the AF request with the mapped information. For example, the NEF may map an AF-Service-Identifier to a DNN and possibly a network slice information, an external ID to an internal ID, a zone ID to a cell ID, as described above.

After receiving the AF request, the PCF 122 generates one or multiple policies according to (or based on) the AF request. The one or multiple policies may include the traffic information, the device information, the leader election indication, the traffic source selection information, the information about validity condition(s), or the like, or a combination thereof. The PCF provides (sends) the one or multiple polices to the TCF 126 in operation 302. The one or multiple policies are indicative of parameters for a leader election for a group of devices.

According to the one or multiple polices, the TCF 126 coordinates traffic routing for the devices identified in the device information, as illustrated by operation 303. Alternatively, operation 303 may be referred to as performing leader election, to elect a member of a group of devices as a leader device. The leader election 303 includes sub-operation 303.1, which involves selecting a leader device. The leader election may also include sub-operation 303.2 which involves selecting traffic sources. The leader election may also include sub-operation 303.3, which involves managing data plane paths. The sub-operations 303.2, 303.3 or both may be optional or omitted in various embodiments.

In operation 303.1, the TCF 126 selects a leader device, that is, the TCF selects a device from candidate leaders identified in the device information to be the leader. For example, the TCF identifies qualifying device(s) among the candidate leaders according to the leader election indication (e.g. more specifically, the information about leader election criteria). There may be one or multiple qualifying devices. Among the qualifying device(s), the TCF selects one device to be the leader. The selected device is referred to as leader device.

In operation 303.2, the TCF 126 selects traffic sources. The TCF may select some or all of candidate traffic sources identified in the device information as traffic sources. If a device is both a candidate leader and a candidate traffic source as identified in the device information and if the device is selected by the TCF as the leader, in some embodiments the TCF may not select the device as a traffic source.

When selecting the leader device (operation 303.1) and/or when selecting the traffic sources (operation 303.2), the TCF may take into account network status (e.g. throughput, delay) and device status (e.g. energy level, computing power level, availability or sufficiency of data related to the application) to optimize network performance and device performance. This may include for example operations to avoid network congestion (e.g. network locations such as DPFs with low throughput) and to balance energy consumption on devices. The TCF may obtain (receive) information about current or statistical network status (e.g. throughput and/or packet delay at individual DPFs) from a network function, e.g. the NWDAF in the 3GPP 5G system, and take such information into account in performing the leader election. The TCF may obtain (receive) information about device status from individual device, e.g. each device provides information about its status when requesting to establish a session and periodically update its status, and take such information into account in performing the selecting of the leader device and/or the traffic sources. The TCF may obtain or receive network conditions and take such information into account in performing the selecting of the leader device and/or the traffic sources.

In operation 303.3, the TCF manages data plane paths for the leader device (selected in operation 303.1) and the traffic sources (selected in operation 303.2). The management may be such that the application traffic is routed to the leader device and that, during the traffic routing, address translation may be performed to translate an application address to a leader address and/or traffic gating may be performed to drop unauthorized traffic (i.e. application traffic originated from devices not selected as traffic sources). The TCF may perform such management (i.e. operation 303.3) by performing a procedure as illustrated in the FIG. 4 and further described below, in which the TCF may interact with the PMF, the leader device, and the traffic source(s). Thus, the TCF initiates data plane path management operations, to cause select traffic to be routed toward the leader device.

Managing data plane paths can include selecting data plane paths toward the leader device. Managing data plane paths can include selecting data plane paths from traffic sources generating the select traffic. The selected data plane paths are for use in routing select traffic from traffic sources to leader devices, from leader devices to traffic sources, or both. Managing data plane paths can include configuration of one or more data plane functions handling select traffic. Such data plane functions may include one or both of: a data plane function operating as a data plane anchor (DPA) for the leader device; and a data plane function operating as a DPA for one or more of the traffic sources. Managing data plane paths can include initiating operation of a PMF to select data plane paths, configure data plane functions, etc.

Note that operation 303 (including sub-operations 303.1, 303.2, 303.3) in FIG. 3 may be performed iteratively, i.e. multiple times in sequence. Each time (i.e. each iteration) that operation 303 is performed, the application traffic may be routed to a selected leader device. In different iterations, different leader devices may be selected, and/or different sets of traffic sources may be selected.

Embodiments of the present disclosure pertain to managing of data plane paths for a group of devices. The group of devices include candidate leader(s) and candidate traffic source(s), for example, as identified by the device information described in embodiments associated to FIG. 3. More particularly, the TCF 126 manages data plane paths for the leader device and the traffic source(s) so that the application traffic is routed to the leader device. The application traffic is identified by the traffic information described in embodiments associated to FIG. 3. The leader device is a device selected or elected (e.g. in operation 303.1 of FIG. 3) to be the leader among the candidate leader(s). When the TCF manages the data plane paths (e.g. in operation 303.3 of FIG. 3), the TCF performs a procedure for example as illustrated in FIG. 4 and described below, in which the device 450 is the selected leader device (in other words, elected leader). The traffic source (TS) 456 is a network entity (e.g. a device or an AS) that sends at least part of the application traffic. In some embodiments, the TS is a device selected (e.g. in operation 303.2 of FIG. 3) from the candidate traffic source(s). In some embodiments, the DPF1 452 and the DPF2 454 are the same network entity. In some embodiments, operation 405 happens before operation 404. In some embodiments, operations 403 and 405 are combined. In some embodiments, operation 406 happens before operation 404.

Referring now in more detail to FIG. 4, in operation 401 the TCF 126 notifies the device 450 about a leader election decision for the application, by sending a notification message to the device. The notification message may be transported to the device through the RAN, for example, when the device is a wireless device such as a UE, and in this case, the notification message may be a NAS message sent to the device or may be included in a NAS message sent to the device. The NAS message may be generated by (and thus sent from) the TCF 126 or generated by (and thus sent from) another network function (e.g. the PMF 128, or a network function managing mobility such as AMF in the 3GPP 5G system). When the NAS message is generated by the other network function, the TCF 126 sends the notification message to the other network function, and the other network function includes the notification message in the NAS message before sending the NAS message to the device.

The notification message indicates the leader device selection, i.e. that the device 450 is selected to be the leader. The leader device selection may be made in operation 303.1 of FIG. 3. The notification message may include information identifying the application (e.g. a DNN or an application ID).

The notification message may further indicate that a traffic associated to the application (e.g. the application traffic identified by the traffic information described above) will be routed (transported) to the device 450.

In operation 401, the device 450 may send a response to the TCF 126. The response may be transported to the TCF through the RAN, for example, when the notification message is transported to the device through the RAN, and in this case, the response may be included in a NAS message sent from the device to the RAN. The RAN may send the NAS message to the TCF 126 directly, or indirectly via another network function (e.g. the PMF 128, or a network function managing mobility such as AMF in the 3GPP 5G system).

The response may be a positive response or a negative response. A positive response confirms the leader election decision, that is, the device agrees to be or act as the leader (i.e. to take the leader role). A negative response indicates that the device rejects or refuses the leader election decision, in other words, that the device does not agree to be or act as the leader.

The response includes information indicating whether the response is a positive response or a negative response. If the response is the positive response, the procedure continues to the operation 402. If the response is the negative response, the procedure stops, and the TCF may perform leader device selection again (e.g. the step 303.1 in FIG. 3), in which the TCF 126 selects a different device to be the leader.

In some embodiments, the TCF 126 sends the notification message to the device via the PMF 128, and the device 450 sends the response to the TCF 126 via the PMF 128. When the RAN is involved in transporting the notification message and the response, the RAN is located between the PMF and the device. When the PMF is involved in this step, the information identifying the application may be included or added in the message by the PMF (e.g. if the message sent from the TCF to the PMF does not include the information identifying the application).

In operation 402, the TCF 126 notifies the PMF 128 about the leader election decision, i.e. that the device 450 is selected to be the leader, for the application, by sending a message to the PMF. The message sent to the PMF indicates that the device 450 is selected to be the leader and includes information identifying the device 450. The message sent to the PMF may further include the information identifying the application (e.g. a DNN or an application ID). In some embodiments, when the PMF is involved in operation 401, operation 402 may be integrated within operation 401 (e.g. such that the TCF 126 notifies the PMF 128 about the leader election decision, and the PMF then notifies the device 450 about the leader election decision). According to this operation, the PMF may be initiated to configure one or more DPFs, for example according to operations 404 and 406.

The TCF may perform operation 402 by providing traffic routing requirements to the PMF. The traffic routing requirements may be generated by the TCF according to police(s) that the TCF received or originating from the PCF (e.g. in operation 302 of FIG. 3). The message sent from the TCF to the PMF in operation 402 may comprise information describing the traffic routing requirements. In some embodiments, when the TCF and the PCF are integrated (e.g. when the PCF implements the TCF's functionalities) the TCF (or the PCF, due to the integration) may provide the traffic routing requirements by providing one or multiple polices to the PMF. The one or multiple policies are generated according to information in the AF request (e.g. in operation 301 of FIG. 3) and include the information describing the traffic routing requirements. The information describing the traffic routing requirements may include one or more of: information about the leader, information about the traffic, information about traffic source(s), information about traffic gating, and information about address translation, which are further described below.

The information about the leader indicates that the device 450 is the leader device and may include information (e.g. a device ID or a network address) identifying the device 450. The information about the leader may further indicate that the application traffic as identified in the information about the traffic should be routed to the device 450.

The information about the traffic may identify the application traffic. In some embodiments, the information about the traffic further indicates that the application traffic should be routed to the leader device as identified in the information about the leader. The information about the traffic may indicate that a traffic that includes one or multiple particular addresses as destination address and/or one or multiple particular port numbers as destination port number is the application traffic. The one or multiple particular addresses and/or the one or multiple particular port numbers are referred to as application addresses and included in the information about the traffic. In some embodiments, the information about the traffic includes, or is included in the traffic information that the TCF 126 received in operation 302 in FIG. 3.

The information about traffic source(s) may include information (e.g. a list of ID(s) or network address(es)) identifying one or multiple traffic sources. The one or multiple traffic sources may include device(s) selected by the TCF 126 from candidate traffic source(s) in operation 303.2 in FIG. 3. The candidate traffic source(s) are identified by the device information that the TCF 126 received in operation 302 in FIG. 3. In some embodiments, the information about traffic source(s) is part of, i.e. included in the device information. In some embodiments, the information about traffic source(s) is mapped from the device information. In some embodiments, the information about traffic source(s) is identical to the device information.

The information about traffic gating, also referred to as traffic gating information, may indicate that certain traffic, e.g. some traffic among those identified by the information about the traffic, should be dropped or not allowed. The certain traffic may originate from one or multiple devices, also referred to as gated devices, and include network address(es) of the one or multiple gated devices as source addresses. In this case, the certain traffic may be indicated by the network address(es) (as source addresses) of the one or more gated devices. The network address(es) may be included in the information about traffic gating, or mapped from the information about traffic gating. For example, the information about traffic gating may include a list of ID(s), which identify(ies) the gated device(s), and the network addresses are mapped from the list of ID(s). An ID in the list of ID(s) may be an ID identifying a single gated device or an ID identifying multiple gated devices (e.g. a group of gated devices). The aforementioned gated devices may be among candidate traffic source(s) that are identified by the device information (which is received by the TCF 126 in operation 302 in FIG. 3) and not selected by the TCF 126 as traffic source(s) (e.g. in operation 303.2 in FIG. 3).

The information about address translation, also referred to as address translation information, may indicate that a destination address in the application traffic identified in the information about the traffic should be translated into another network address. In some embodiments, the destination address is an application address that is included/used in the information about the traffic for identifying the application traffic. The other network address is associated to the leader device 450 and is referred to as leader address. This information may include the destination address. This information may further include the leader address. In some embodiments, the leader address is included in the information about the leader for identifying the leader device 450. In some embodiments, the information about address translation does not include the leader address and may indicate the leader address is to be allocated. In this case, the PMF will allocate the leader address, as described for example in operations 404 and 406. The address translation information can include network addresses to be translated and the network addresses that such network addresses are to be translated into.

In various embodiments, the address translation described above can include destination address translation. In this case, the destination address in a packet is translated, for example, for a packet from a traffic source (and targeting the leader), the packet's destination address is changed from an application address to the leader address. In various embodiments, the address translation described above can include source address translation. In this case, the source address in a packet is translated, for example for a packet from the leader (and targeting a traffic source), the packet's source address is changed from the leader address to an application address. The application address in the destination address translation or in the source address translation is included/used in the information about the traffic for identifying the application traffic.

When the information about address translation includes the leader address, the leader address may be allocated by the TCF 126 according to the information received from the PCF 122 in operation 302 in FIG. 3, or the leader address may be received by the TCF 126 from the PCF 122 in operation 302 in FIG. 3. According to the information about address translation, the PMF may instruct/configure a DPF (e.g. DPF1 452 or DPF2 454) to perform the address translation for the application traffic, as described in operations 404 and 406. Accordingly, the DPF is configured to detect and process select traffic and route the select traffic toward the leader device.

Furthermore in operation 402, the PMF 128 may respond to the TCF 126, acknowledging the receipt of the message. The response may be optional, for example, when the operation 407 is performed and used as an acknowledgement.

In operation 403, the PMF 128 (re)selects a data plane path for the device 450 according to the message (and information in the message) received from the TCF 126 in operation 402. The data plane path connects the device and the DPF1 452, and will be used to transport the application traffic from the DPF1 452 to the device 450. As described above, the data plane path may be associated to a session (e.g. a PDU session in the 3GPP 5G system) of the device 450.

When (re)selecting the data plane path for the device 450, the PMF 128 selects the DPF1 452 as a DPA of the device and includes DPF1 in the data plane path. The PMF may consider data plane paths related to traffic source(s) identified in the information about traffic source(s) during the (re)selecting of the data plane path for the device 450 so as to ensure data plane efficiency. This step may be optional or omitted in various embodiments.

In operation 404, the PMF 128 configures a DPA of the device 450 to detect the application traffic and to route the application traffic toward the device 450 along a data plane path. The data plane path connects the device 450 and the DPA of the device. The DPA of the device is the DPF1 452; the data plane path is selected by the PMF, e.g. in operation 403.

The PMF 128 may generate packet detection rule(s) based on the information about the traffic (received from the TCF 126 in operation 402). The PMF provides the packet detection rule(s) to the DPF1 452 in this operation 404. Later (e.g. in operation 409.4), the DPF1 452 will detect the application traffic according to the packet detection rule(s).

In some embodiments, when the DPF2 454 is configured/instructed (operation 406) to perform address translation (e.g. in operation 409.2), wherein a destination address (which is an application address, as described above) in the application traffic is translated into or replaced with another network address (which is the leader address, as described above) by the DPF2, the packet detection rule(s) provided to the DPF1 452 includes the leader address and indicates that a traffic including the leader address as destination address is, or is part of, the application traffic. The leader address may be included (specified) in the information about address translation received (in operation 402) by the PMF 128 or be allocated by the PMF 128. In some embodiments, when the DPF2 454 is not configured/instructed to perform the address translation, the packet detection rule(s) provided to the DPF1 452 include(s) one or multiple application addresses and indicates a traffic including any one of the application address(es) as destination address is, or is part of the application traffic. The application address(es) may be included (specified) in the information about the traffic.

In operation 405, when the traffic source (TS) 456 is a device, the PMF 128 (re)selects a data plane path for the TS 456 according to the message (and information in the message) received from the TCF 126 in operation 402. The data plane path connects the TS and the DPF2 454 and will be used to transport the application traffic from the TS to the DPF2.

When (re)selecting the data plane path for the TS 456, the PMF 128 may select the DPF2 454 as a DP anchor (DPA) of the TS 456 and includes DPF2 in the data plane path. The PMF 128 may take into account the data plane path of the device (which may be selected in operation 403, for example) during the (re)selecting of the data plane path of the TS so as to facilitate data plane efficiency. This step may be optional or omitted in various embodiments.

In some embodiments, the PMF 128 performs operations 405 and 403 jointly, e.g. at the same time before operation 404.

In operation 406, the PMF 128 configures the DPF2 454 to detect the application traffic and to route the application traffic toward the DPF1 452 through a data plane path connecting the DPF1 and DPF2. The data plane path may include one or multiple data plane tunnels. The data plane path may be selected by the PMF, e.g. in operation 403 or 405, and configured by the PMF, e.g. in operations 404 and 406. Later, the DPF2 454 may detect and route (e.g. in operation 409.3) the application traffic toward the DPF1 452 accordingly.

The application traffic is received by the DPF2 454 from the TS 456. If the TS is a device, the DPF2 receives the application traffic along a data plane path connecting the TS and the DPF2. The data plane path is selected by the PMF 128 for the TS and includes the DPF2 as a DP anchor of the TS. The DPF2 is selected as the DP anchor of the TS and included in the data plane path by the PMF when the PMF selects the data plane path. The PMF may select the data plane path for the TS in operation 405.

In various embodiments, the PMF 128 may generate packet detection rule(s) based on the information about the traffic (received from the TCF 126 in operation 402). The PMF 128 provides the packet detection rule(s) to the DPF2 454 in operation 406. Later (e.g. in operation 409.2), the DPF2 454 will detect the application traffic according to the packet detection rule(s). The packet detection rule(s) provided to the DPF2 454 include(s) one or multiple application addresses and indicates that a traffic that includes any of the one or multiple application addresses as destination address is or is part of the application traffic. The one or multiple application addresses may be included (specified) in the information about the traffic.

According to the information about address translation (received from the TCF 126 in operation 402), the PMF 128 may instruct or configure, as part of operation 404 or 406, a DPF (i.e. the DPF1 452 or the DPF2 454, respectively) to perform (operation 409.4 or 409.2) the address translation for the application traffic. In some embodiments, the PMF instructs/configures only one of the DPF1 452 and the DPF2 454 to perform the address translation for the application traffic.

The PMF 128 may generate address translation rule(s) based on the information about address translation and provides the address translation rule(s) to the DPF (i.e. the DPF1 452 or the DPF2 454) when configuring the DPF (in operation 404 or 406, respectively) to perform the address translation for the application traffic. The address translation rule(s) indicates to translate a destination address into, or replace the destination address with, a translated network address. The destination address is an application address included (for identifying the application traffic) in the information about the traffic and may also be included in the address translation rule(s). The translated network address is the leader address and is included in the address translation rule(s). The leader address may be included in the information about address translation or be generated by the PMF 128, as further described below.

In some embodiments, the leader address is associated to the device 450. In some embodiments, the leader address is received by the PMF 128 from the TCF 126 in operation 402 (e.g. as part of the information about the leader, more specifically, as the network address identifying the device 450 in the information about the leader). In some embodiments, the leader address is allocated by the PMF 128 according to information about address translation. For example, when the information about address translation indicate the leader address is to be allocated or when the information about address translation does not include the leader address, the PMF allocates the leader address.

According to the address translation rule(s), the DPF (i.e. the DPF1 452 or the DPF2 454) performs the address translation for the application traffic (in operation 404 or 406, respectively), where the DPF translates a destination address in the application traffic into, or replaces the destination address with the leader address, before routing (in operation 409.5 or 409.3, respectively) the application traffic. As such, when the DPF routes application traffic, the application traffic includes the leader address as destination address. In some embodiments, the destination address before the address translation is included in the address translation rule(s).

According to the information about traffic gating (received from the TCF 126 in operation 402, also referred to as traffic gating information), the PMF 128 may instruct or configure a DPF (e.g. the DPF1 452 or the DPF2 454) to perform the traffic gating for the application traffic (e.g. in operation 404 or 406, respectively). In some embodiments, the PMF instructs or configures only one of the DPF1 452 and the DPF2 454 to perform the traffic gating for the application traffic.

The PMF 128 may generate traffic gating rule(s) based on the information about traffic gating and provides the rule(s) to the DPF (i.e. the DPF1 452 or the DPF2 454) when instructing/configuring (i.e. in operation 404 or 406, respectively) the DPF to perform the traffic gating for the application traffic. The traffic gating rule(s) indicate(s) that certain traffic, which originates from one or multiple gated devices, should be dropped or not allowed. The traffic gating rule(s) may include information identifying the certain traffic, for example, network address(es) (as source addresses) of the one or more gated devices, which may be devices other than selected traffic sources. The network address(es) may be included in the information about traffic gating. In some embodiments, the network address(es) are mapped from the information about traffic gating. For example, the information about traffic gating may include a list of ID(s), which identify(ies) the gated device(s), and the network addresses are mapped from the list of ID(s). An ID in the list of ID(s) may be an ID identifying a single gated device or an ID identifying multiple gated devices (e.g. a group of gated devices). The aforementioned gated devices may be among candidate traffic source(s) that are identified by the device information (which is received by the TCF 126 in operation 302 in FIG. 3) and not selected by the TCF 126 as traffic source(s) (e.g. in operation 303.2 in FIG. 3). According to the traffic gating rule(s), the DPF performs (in operation 409.2 or 409.4) the traffic gating for the application traffic, wherein the DPF identifies and drops the certain traffic from the application traffic. The DPF detects (in operation 409.2 or 409.4) the application traffic according the packet detection rule(s) received (i.e. in operation 404 or 406) from the PMF 128 as described elsewhere in this disclosure.

In operation 407, the PMF 128 notifies the TCF 126 that the data plane has been configured with respect to the traffic routing requirements (which are received in operation 402). The notification sent to the TCF may include the leader address, for example, when the leader address is allocated by the PMF. The notification sent to the TCF may serve as a response or an acknowledgement to the message received from the TCF in operation 402, for example, when the PMF did not send a response to the TCF in operation 402.

In operation 408 (comprising sub-operation 408.1, sub-operation 408.2, or both), after receiving the notification from the PMF 128, the TCF 126 determines that the data plane is ready. The TCF triggers data communication related to the application. During the data communication, the TS 456 sends the application traffic.

In sub-operation 408.1, the TCF 126 sends a notification to the device 450. The notification may include information identifying the application (e.g. a DNN or an application ID). The notification indicates to the device 450 that the device can start data communication related to the application, or that the device may expect to receive data traffic related or associated to the application (i.e. such traffic is to be expected), or a combination thereof. Sub-operation 408.1 may include the leader address and indicate whether to report local computing status (associated to the application being supported). For example, the TCF includes the leader address in the notification sent to the device 450. According to the notification, the device 450 will recognize data traffic including the leader address (as destination address) as application traffic, and accepts and processes the data traffic in operation 409.5. The TCF further indicates to report local computing status in the notification sent to the device 450. According to the notification, the device 450 reports its local computing status in operation 410. Local computing status may indicate whether or not local computing related to the application is completed, or how much is completed, e.g. in terms of percentage or ratio.

If the device 450 is a wireless device, the notification may be sent to the device through the RAN, and the notification may be included a NAS (non-access stratum) message. The NAS message is sent to the RAN, and the RAN transports the NAS message to the device. The NAS message may be generated by (and thus sent from) the TCF 126 or generated by (and thus sent from) another network function (e.g. the PMF 128, or a network function managing mobility such as AMF in the 3GPP 5G system). In the case that the NAS message is generated by the other network function, the TCF sends the notification to the other network function, which then includes or indicates the notification in the NAS message before sending the NAS message.

In sub-operation 408.2, the TCF 126 sends a notification to the TS 456. The notification may include information identifying the application (e.g. a DNN or an application ID). The notification may indicate that the TS is selected as traffic source for the application. The notification may further indicate to the TS that the TS can start data communication related to the application, or that the TS may expect to receive data traffic related or associated to the application (i.e. such traffic is to be expected), or both. Sub-operation 408.2 may include the leader address. The notification can thus indicate that the TS can now perform data communication conforming to the select traffic, and that such select traffic will be routed to the leader.

If the TS 456 is a wireless device, the notification is transported to the TS through the RAN, and the notification is included in a NAS (non-access stratum) message. The NAS message is sent to the RAN, and the RAN transports the NAS message to the TS 456. The NAS message may be generated by (and thus sent from) the TCF 126 or generated by (and thus sent from) another network function (e.g. the PMF 128, or a network function managing mobility such as AMF in the 3GPP 5G system). In the case that the NAS message is generated by the other network function, the TCF sends the notification to the other network function, which then includes the notification in the NAS message before sending the NAS message.

If the TS 456 is an AS, the TCF 126 sends the notification to an AF that subscribes to the notification. In some embodiments, the AF is the AF 134 in FIG. 1, and the AF subscribes to the notification in operation 301 in FIG. 3 when the AF requests to perform the leader election. For example, the AF request in operation 301 in FIG. 3 may indicate that the AF subscribes to the notification, and the policy or policies sent from the PCF 122 to the TCF 126 in operation 302 of FIG. 3 accordingly indicates that the AF subscribes to the notification. The notification sent from the TCF may be transported to the AF via the network exposure function (NEF) 120 in FIG. 3. The AF after receiving the notification may in turn notify the AS 132 to start the data communication.

In operation 409, data communication related to the application takes place between the TS 456 and the device 450, e.g. due to the trigger from the TCF 126 in operation 408. In operation 409, data traffic related to the application is transported between the TS 456 and the device 450, via the DPF 1 452 and the DPF 2 454.

In sub-operation 409.1, the TS 456 sends the application traffic (which comprises protocol data units (PDU)). The application traffic is sent to the DPF2 454. If the TS is a device, the application traffic is sent to the DPF2 along a data plane path of the TS (which may be selected by the PMF in operation 405), and the data plane path goes through the RAN.

In sub-operation 409.2, the DPF2 454 detects the application traffic and processes the application traffic according to the configuration or instruction received (operation 406) from the PMF 128.

The DPF2 454 detects the application traffic according to the packet detection rule(s) received in operation 406. When processing the application traffic, the DPF2 may perform address translation according to the address translation rule(s) received in operation 406. The address translation rule(s) indicates a destination address should be translated into or replaced with the leader address. The leader address is included in the address translation rule(s). When performing the address translation, the DPF2 translates a destination address in the application traffic into, or replaces the destination address with the leader address as indicated by the address translation rule(s). As such, when the DPF2 routes (e.g. in operation 409.3) the application traffic, the application traffic includes the leader address as destination address.

In operation 409.3, the DPF2 454 routes (sends) the application traffic toward the DPF1 452 through a data plane path (which comprises one or multiple data plane tunnels) that connects the DPF2 and DPF1. The data plane path may be selected by the PMF 128, e.g. in operation 403 or 405, and configured by the PMF 128, e.g. in operations 404 and 406.

In sub-operation 409.4, the DPF1 452 detects the application traffic and processes the application traffic according to the configuration/instruction received (in operation 404) from the PMF 128.

The DPF1 452 detects the application traffic according to the packet detection rule(s) received in operation 404. When processing the application traffic, the DPF1 may perform address translation according to the address translation rule(s) received in operation 404. The address translation rule(s) indicates a destination address should be translated into or replaced with the leader address. The leader address is included in the address translation rule(s). When performing the address translation, the DPF1 translates a destination address in the application traffic into, or replaces the destination address with the leader address as indicated by the address translation rule(s). As such, when the DPF1 routes (e.g. in sub-operation 409.5) the application traffic, the application traffic includes the leader address as destination address. Because the address is changed and not given to sources, destination address translation may facilitate routing of packets toward the leader while masking the address of the leader from the sources of such packets.

In sub-operation 409.5, the DPF1 452 routes (sends) the application traffic toward the device 450 along a data plane path of the device. The data plane path may be selected by the PMF 128 in operation 403.

In sub-operation 409.6, the device 450 sends data traffic. The data traffic may be generated by the device according to the application traffic received in operation 409.5. The data traffic includes the leader address as source network address. The data traffic is routed to the DPF1 452 along a data plane path of the device. The data plane path may be selected by the PMF 128 for the device in operation 403. In some embodiments, the data traffic includes an application address as source address, the application address being one included or used in the information about the traffic for identifying the application traffic (as described in operation 402). In some embodiments, the data traffic includes the leader address as source address. The leader address may be provided to the device 450 in operation 401 or 408.1.

The DPF1 452 processes the data traffic according to configuration or instruction received from the PMF 128 in operation 404. In some embodiments, the data traffic includes the leader address as source address, and when processing the data traffic, the DPF1 may perform address translation that is reverse to the address translation performed in the sub-operation 409.2 or 409.4. The address translation is referred to as reverse address translation, and was also described above as source address translation. The DPF1 may perform the reverse address translation (i.e. source address translation) according to one or multiple rules, which are received in operation 404 and referred to as reverse address translation rule(s) (equivalently, source address translation rule(s)). The reverse address translation rule(s) indicate(s) that a source address that matches the leader address should be translated into or replaced with an application address, the application address being one included and used in the information about the traffic for identifying the application traffic as described in operation 402. The reverse address translation rule(s) include the application address. The reverse address translation rule(s) may further include the leader address. When performing the reverse address translation, the DPF1 translates a source address (that matches the leader address) in the data traffic into, or replaces the source address with the application address, as indicated in the reverse address translation rule(s). As such, when the DPF1 routes (e.g. in sub-operation 409.7) the data traffic, the data traffic includes the application address as source address. The reverse address translation (i.e. source address translation) may facilitate routing of the return packets while masking an address of the leader device from destinations of the packets of the return traffic.

In sub-operation 409.7, the DPF1 452 sends the data traffic toward the DPF2 454 through a data plane path (which includes one or multiple data plane tunnels). The data plane path may be selected by the PMF 128, e.g. in operation 403 or 405, and configured by the PMF, e.g. in operations 404 and 406. The data plane path may be the data plane path used in the sub-operation 409.3.

The DPF2 454 processes the data traffic according to configuration/instruction received from the PMF 128 in operation 406. When processing the data traffic, the DPF2 may perform the reverse address translation described above, which is reverse to the address translation performed in the sub-operation 409.2 or 409.4. The DPF2 may perform the reverse address translation according to the reverse address translation rule(s) described above. In this case, the reverse address translation rule(s) is (are) received by the DPF2 from the PMF 128 in operation 406. When performing the reverse address translation, the DPF2 translates a source address (that matches the leader address) in the data traffic into, or replaces the source address with an application network address, as indicated in the reverse address translation rule(s). As such, when the DPF2 routes (e.g. in sub-operation 409.8) the data traffic, the data traffic includes the application address as source address.

In some embodiments, only one or DPF1 452 and DPF2 454 receives the reverse address translation rule(s) from the PMF 128 and performs the reverse address translation accordingly. For example, the PMF 128 provides the reverse address translation rule(s) either to the DPF1 452 in operation 404 or to the DPF2 454 in operation 406.

In sub-operation 409.8, the DPF2 454 sends the data traffic toward the TS 456. If the TS is a device, the data traffic is sent to the DPF2 along a data plane path of the TS (which may be selected by the PMF 128 in operation 405).

At a given time, the device 450 may determine to no longer act (stop acting) as the leader and notifies the TCF 126 about this determination. The device sends such a notification to the TCF at operation 410, for example as included in an NAS message. Accordingly, the notification indicates that the device 450 has determined to stop acting as the leader for the application (i.e. receiving the application traffic) and that the current iteration of coordinating traffic routing or performing leader election (operation 303) for the application is finished. The notification may include information (e.g. a DNN or an application ID) identifying the application. According to the notification, the TCF 126 may perform a next iteration of coordinating traffic routing (or leader election) for the application (operation 303 in FIG. 3). In some embodiments, the notification is first sent to the PMF 128, and the PMF then forwards the notification to the TCF 126. In some embodiments, the information identifying the application is included in the notification by the PMF before the PMF forwarding the notification to the TCF. The operation 410 may indicate local computing status of the leader device, according to which the TCF can evaluate a termination condition and determine whether or not to perform a new iteration of coordinating traffic routing or leader election (operation 303) according to the evaluation result, and associated data path management. For example, the termination condition can be that, among the candidate leaders identified in the device information (the device information is described in operation 301), a ratio of devices that have been selected as leader and are in certain status (e.g. local computing related to the application is completed, or completed to a particular percentage or ratio) is larger or not smaller than a threshold value. If the termination condition is met as indicated by the evaluation result, the TCF terminates the leader election (not performing a new iteration of leader election); otherwise, the TCF performs a new iteration of coordinating traffic routing. The termination condition may be described in the AF request (operation 301) and in the policies sent (operation 302) to the TCF. For example, the leader election indication in the AF request may include information describing the termination condition. The information describing the termination condition specifies the threshold value and the certain status. The policies sent to the TCF includes the leader election indication, thus the information describing the termination condition.

It is noted that the TCF may enforce network address translation, traffic gating, or both, according to the policies generated (e.g. by the PCF) based on the AF request. This enforcement may be carried out via operations 402, 404, 405, 409.2 and 409.4. Address translation may be omitted for example when operation 408.2 includes an indication of the leader address. Address translation may interchange an address associated to an application being supported, or an address associated with a generic leader device, with an address of the current leader device. According to traffic gating, traffic of unselected traffic sources may be dropped, or traffic of selected traffic sources only may be retained, or both.

It is noted that the TCF coordinates data communication between the leader device and the traffic sources, for example via operations 401, 402, 408.1, 408.2 and 410.

In view of the above disclosure, embodiments provide for the provisioning of leader election requirements. A technical effect of such embodiments is to allow the AF to request the system to perform leader election for a traffic so that the traffic is routed to the leader (a device dynamically selected by the system).

In further view of the above disclosure, embodiments provide for leader election, including providing notification indicative of the election decision, notification of termination of leader status of a device, or both. A technical effect of such embodiments is to facilitate synchronization of a system of devices with the selected leader device and with the AF involved with the leader election decision. In this way the leader may be dynamically elected and traffic routing may be managed properly.

In further view of the above disclosure, embodiments provide for managing of data plane path to support traffic routing toward the leader, including traffic gating and address translation (and reverse address translation). A technical effect of such embodiments is to allow only authorized traffic to be routed to the leader, without disclosing the leader devices identity information.

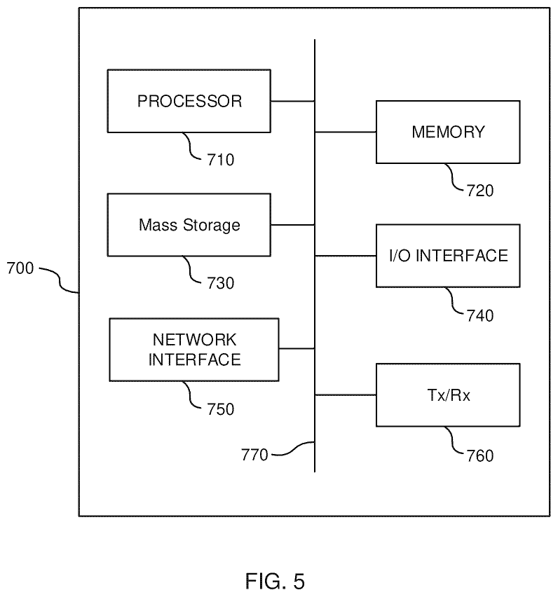

FIG. 5 is a schematic diagram of an electronic device 700 that may perform any or all of operations of the above methods and features explicitly or implicitly described herein, according to different embodiments of the present disclosure. For example, a computer equipped with network function may be configured as an electronic device 700.

As shown, the device includes a processing electronics in the form of a processor 710, such as a Central Processing Unit (CPU) or specialized processors such as a Graphics Processing Unit (GPU) or other such processor unit, memory 720, non-transitory mass storage 730, I/O interface 740, network interface 750, and a transceiver 760, all of which are communicatively coupled via bi-directional bus 770. According to certain embodiments, any or all of the depicted elements may be utilized, or only a subset of the elements. Further, the device 700 may contain multiple instances of certain elements, such as multiple processors, memories, or transceivers. Also, elements of the hardware device may be directly coupled to other elements without the bi-directional bus. Additionally or alternatively to a processor and a memory, other processing electronics, such as integrated circuits, application specific integrated circuits, field programmable gate arrays, digital circuitry, analog circuitry, or the like, or a combination thereof may be employed for performing the required logical operations. Processing electronics may include one or more of semiconductor chips, and semiconductor chiplets. Some processing electronics may operate without the use of external memory, for example in the case that the electronics are hardwired to operate in a particular manner.

The memory 720 may include any type of non-transitory memory such as static random access memory (SRAM), dynamic random access memory (DRAM), synchronous DRAM (SDRAM), read-only memory (ROM), any combination of such, or the like. The mass storage element 730 may include any type of non-transitory storage device, such as a solid state drive, hard disk drive, a magnetic disk drive, an optical disk drive, USB drive, or any computer program product configured to store data and machine executable program code. According to certain embodiments, the memory 720 or mass storage 730 may have recorded thereon statements and instructions executable by the processor 710 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the implementations of this application as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present application may be implemented by using hardware only or by using software and a necessary universal hardware platform. Based on such understandings, the technical solution of the present application may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present application. For example, such an execution may correspond to a simulation of the logical operations as described herein. The software product may additionally or alternatively include a number of instructions that enable a computer device to execute operations for configuring or programming a digital logic apparatus in accordance with embodiments of the present application.

Although the present application has been described with reference to specific features and embodiments thereof, it is evident that various modifications and combinations can be made thereto without departing from the disclosure. The specification and drawings are, accordingly, to be regarded simply as an illustration of the present application as defined by the appended claims, and are contemplated to cover any and all modifications, variations, combinations or equivalents that fall within the scope of the present application.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

What is claimed is:

1. A method comprising:
receiving, by a first network function in a communication network, one or more policies indicative of parameters for a leader election for a group of devices;
performing, by the first network function, the leader election to elect a member of the group of devices as a leader device based on the one or more policies; and
initiating, by the first network function, data plane path management operations to cause select traffic to be routed toward the leader device.

2. The method of claim 1, further comprising:
receiving, by a second network function of the communication network, a request to perform the leader election for the group of devices; and
sending, by the second network function, toward the first network function, the one or more policies generated based on the request.

3. The method of claim 2, wherein the request includes one or more of:
traffic information for use in identifying the select traffic for said causing the select traffic to be routed toward the leader device;
device information for use in identifying the group of devices;
device information for use in identifying one or more traffic sources generating the select traffic;
a leader election indication indicative that the leader election is to be performed;
traffic source selection information indicating whether or not all devices indicated by the device information can act as the traffic sources;
information indicative of validity conditions specifying time, location, or both time and location at which the first function is to perform the leader election; or
information indicative of validity conditions specifying time, location, or both time and location at which the first function is to perform selection of the traffic sources.

4. The method of claim 3, wherein the leader election indication includes one or more leader election criteria to be respected or considered during the leader election, and wherein the one or more leader election criteria include one or more of: computing power, remaining energy, availability of data, or sufficiency of data.

5. The method of claim 3, wherein the leader election indication is further indicative that the select traffic is to be routed to the leader device.

6. The method of claim 2, further comprising:
sending, by a third network function of the communication network, the request toward the second network function.

7. The method of claim 1, wherein the select traffic is identified based on one or more of: a source address, a destination address, or one or more port numbers.

8. The method of claim 1, wherein the data plane path management operations comprise one or more of: selection of data plane paths toward the leader device, selection of data plane paths from traffic sources generating the select traffic, or configuration of one or more data plane functions handling said select traffic.

9. The method of claim 8, wherein the one or more data plane functions include one or more of: a first data plane function operating as a data plane anchor (DPA) for the leader device; or a second data plane function operating as the DPA for one or more of the traffic sources.

10. The method of claim 1, further comprising:
selecting, by the first network function, one or more traffic sources from the group of devices or from another group of devices, the traffic sources being potential sources of the select traffic.

11. The method of claim 1, wherein the data plane path management operations comprise:
initiating notification to said member of the group of devices, that said member is selected to be the leader device; and
initiating, via messaging, operation of a path management function (PMF) to configure one or more data plane functions (DPFs) to detect and process select traffic and route the select traffic toward the leader device.

12. The method of claim 11, wherein the notification that said member is selected to be the leader device is included in a non-access stratum (NAS) message sent to said member of the group of devices through a radio access network (RAN).

13. The method of claim 1, wherein the data plane path management operations comprise:
initiating, via messaging, operation of a path management function (PMF) to select data plane (DP) paths for use in routing the select traffic from one or more traffic sources toward the leader device, routing traffic from the leader device to the one or more traffic sources, or both.

14. The method of claim 1, further comprising:
subsequently receiving, by the first network function, a third notification from the leader device that the leader device has determined to stop acting as the leader device; and
in response to the notification that the leader device has determined to stop acting as the leader device, initiating, by the first network function, a next iteration of leader device selection and associated data path management.

15. The method of claim 14, wherein the notification from the leader device that the leader device has determined to stop acting as the leader device is included in a non-access stratum (NAS) message sent to one or more traffic sources through a radio access network (RAN).

16. A network function in a communication network, wherein the network function comprises processing electronics and a network interface, and is configured to:
receive one or more policies indicative of parameters for a leader election for a group of devices;
perform the leader election to elect a member of the group of devices as a leader device based on the one or more policies; and
initiate data plane path management operations to cause select traffic to be routed toward the leader device.

17. A system in a communication network, wherein the system comprises a first network function and a second network function, and wherein:
the first network function comprises processing electronics and a network interface, and is configured to:
receive one or more policies indicative of parameters for a leader election for a group of devices;
perform the leader election to elect a member of the group of devices as a leader device based on the one or more policies; and
initiate data plane path management operations to cause select traffic to be routed toward the leader device; and
the second network function is configured to:
receive a request to perform the leader election for the group of devices; and
send, toward the first network function, the one or more policies generated based on the request.

18. The system of claim 17, further comprising an application function (AF) configured to send the request toward the second network function.

19. The system of claim 17, further comprising a path management function (PMF), wherein:
said data plane paths management operations comprise: initiating, via messaging, operation of a path management function (PMF) to select data plane (DP) paths for use in routing the select traffic from one or more traffic sources toward the leader device, routing traffic from the leader device to the one or more traffic sources, or both; and
the PMF is configured to select the DP paths.

20. The system of claim 17, further comprising one or more data plane functions (DPFs), wherein said data plane paths management operations comprise:
initiating notification to said member of the group of devices, that said member is selected to be the leader device; and
initiating, via messaging, operation of a path management function (PMF) to configure the one or more DPFs to detect and process select traffic and route the select traffic toward the leader device, wherein the one or more DPFs are configured to perform address translation, traffic gating, or both.
